(19) United States
(12) Patent Application Publication
(10) Pub. No.: US 2014/0290673 A1
(43) Pub. Date: Oct. 2, 2014

(54) LAMP COVER AND ELECTRONIC CIGARETTE USING THE SAME

(71) Applicant: Qiuming Liu, Shenzhen (CN)

(72) Inventor: Qiuming Liu, Shenzhen (CN)

(21) Appl. No.: 13/893,907

(22) Filed: May 14, 2013

Related U.S. Application Data
(63) Continuation of application No. PCT/CN2013/073286, filed on Mar. 27, 2013.

(51) Int. Cl. A24F 47/00; F21V 21/00

(52) U.S. Cl. CPC A24F 47/002; F21V 21/00
USPC 131/329; 362/382

(57) ABSTRACT

This invention discloses a lamp cover and an electronic cigarette. The lamp cover comprises a first lamp cap and a second lamp cap which two are connected with each other detachably or fixedly to from the whole lamp cover. The light emitted from the light emitting diode will change in its color when passing through the lamp cover, so that the electronic cigarette using such lamp cover can result in bright and colorful light or color effect and further meet user's individual requirement. Meanwhile, air inlets can be arranged on the contact surface of the first and second lamp caps that form the lamp cover, thus achieving more hidden arrangement for air inlet and more aesthetic appearance without influencing the smoothness of airflow.

### CROSS-REFERENCE TO RELATED APPLICATIONS

This application is a continuation of International Patent Application No. PCT/CN2013/073286, with an international filing date of Mar. 27, 2013, designating the United States, now pending. The contents of these specifications are incorporated herein by reference.

### FIELD OF THE INVENTION

This invention relates to a technical field of daily electronic products, and more particularly to a lamp cover and an electronic cigarette using the same.

### BACKGROUND OF THE INVENTION

Electronic cigarette is a simulated electronic tobacco product, by which smoking effect is achieved when people suck some atomizing tobacco tar. Since a cigarette butt is accompanied with twinkling firelight during smoking in the case of a litten cigarette, a light emitting diode (LED) is disposed at the end opposite to a suction nozzle in the electronic cigarette for the purpose of fitting people's usage habit and achieving simulation effect, which LED will twinkle during the usage of electronic cigarette and thus bring about more real using process. At present, LED can emit various kinds of lights; for instance, red, green and yellow lights are respectively emitted by GaAsP diode, GaP diode and SiC diode. For the reason that the light color of a cigarette butt is relatively close to red light, the GaAsP diode emitting red light is generally used by the existing electronic cigarette manufacturer, and transparent or semi-transparent material is used to make colorless lamp cover for enclosing the diode inside the electronic cigarette simultaneously.

As shown in FIGS. 1-2, the lamp cap 2 mounted at the end of a cigarette rod 1 is usually a cylindrical structure in the electronic cigarette and the lamp cap for electronic cigarette. It comprises a top cover 212 and hollow bottomless lamp cap columns 211 extending downwards from a lower surface of the top cover 212.

The outer diameter of the lamp cap column 211 should be matched with the inner diameter of the cigarette rod 1. In this circumstance, the external wall of the lamp cap column 211 is appressed onto the inner wall of the cigarette rod 1 and thus the lamp cap 2 is connected with the cigarette rod 1 when the lamp cap 2 is engaged into the cigarette rod 1.

Although such electronic cigarette has good simulation effects, single light color still results in aesthetic fatigue over a long time of usage. Meanwhile, users of the electronic cigarette take the twinkling light of the LED as visual enjoyment and working sign for electronic cigarette in more extent. That is why it is necessary to manufacture some electronic cigarettes with bright and colorful light or color effect in such a way that the resulting electronic cigarette fits the user's demand and has improved user experience.

### SUMMARY OF THE INVENTION

In order to solve the above-mentioned problems, this invention provides a lamp cover and an electronic cigarette which meet user's individual requirement by performing some improvement on the previous structure of lamp cap and thus bringing about bright and colorful light or color effect to the electronic cigarette.

The technical solution adopted in this invention to solve its technical problems is as follows: a lamp cover is provided which comprises a first lamp cap and a second lamp cap which two are connected with each other detachably or fixedly. The first lamp cap comprises a top cover and lamp cap columns, wherein the latter have a receiving cavity and extend axially from a bottom surface of the top cover. The second lamp cap is located on an upper end surface of the top cover or within the receiving cavity.

In the lamp cover, the shape of the second lamp cap is adaptive with that of the upper end surface of the top cover, and the second lamp cap covers the upper end surface.

In the lamp cover, at least one vent groove is disposed on a surface of the second lamp cap by which it is in contact with the first lamp cap, and at least one vent hole is correspondingly disposed on the top cover of the first lamp cap. The vent groove and the vent hole form a passage for air flow.

In the lamp cover, at least one protrusion is disposed on the second lamp cap, and the upper end surface of the top cover is disposed with a recess at the location corresponding to the protrusion. Alternatively, at least one recess is disposed on the second lamp cap, and the upper end surface of the top cover is disposed with a protrusion at the location corresponding to the recess.

In the lamp cover, the second lamp cap is adhered onto the first lamp cap.

In the lamp cover, the second lamp cap is sleeved within the receiving cavity and its cross section is U-shaped.

In the lamp cover, the second lamp cap is in interference fit with the receiving cavity or is adhered within the receiving cavity.

In the lamp cover, both the first and second lamp caps are made of transparent or semi-transparent material.

A lamp cover for electronic cigarette is also provided in this invention. It comprises a first lamp cap and a second lamp cap in the shape of circle. The first lamp cap comprises a top cover and lamp cap columns extending axially from a bottom surface of the top cover. A concave part for accommodating the lamp cap column is arranged on an end surface of the second lamp cap against which the lamp cap column abuts, and external thread is arranged on an outer circumference on one side of the second lamp cap distal from the top cover.

In the lamp cover, the first lamp cap is made of transparent or semi-transparent material, the second lamp cap is made of metal, transparent or semi-transparent material, and the first and second lamp caps are adhered together.

Also an electronic cigarette using the above-mentioned lamp cover is provided in this invention. This electronic cigarette comprises a lamp cover and a cigarette rod. The lamp cover is connected in proximity to one end of the cigarette rod with a built-in light emitting diode. The lamp cover comprises a first lamp cap and a second lamp cap which two are connected with each other detachably or fixedly. The first lamp cap comprises a top cover and lamp cap columns, wherein the latter have a receiving cavity and extend axially from a bottom surface of the top cover. The second lamp cap is located on an upper end surface of the top cover or within the receiving cavity. The light emitted from the light emitting diode passes through the first and second lamp caps so as to change the light color.

In the electronic cigarette, the shape of the second lamp cap is adaptive with that of the upper end surface of the top cover, and the second lamp cap covers the upper end surface.

In the electronic cigarette, at least one vent groove is disposed on a surface of the second lamp cap by which it is in contact with the first lamp cap, and at least one vent hole is correspondingly disposed on the top cover of the first lamp cap. The vent groove and the vent hole form a passage for air flow.

In the electronic cigarette, several protrusions are disposed on the second lamp cap, and the upper end surface of the top cover is disposed with recesses at the location corresponding to the protrusions.

In the electronic cigarette, several recesses are disposed on the second lamp cap, and the upper end surface of the top cover is disposed with protrusions at the location corresponding to the recesses.

In the electronic cigarette, the second lamp cap is sleeved within the receiving cavity and its cross section is U-shaped.

In the electronic cigarette, the second lamp cap is in interference fit with the receiving cavity.

In the electronic cigarette, both the first and second lamp caps are made of transparent or semi-transparent material.

Also another electronic cigarette is provided in this invention. This electronic cigarette comprises a lamp cover and a cigarette rod. The lamp cover is connected in proximity to one end of the cigarette rod with a built-in light emitting diode. The lamp cover comprises a first lamp cap and a second lamp cap in the shape of circle. The first lamp cap comprises a top cover and lamp cap columns extending axially from a bottom surface of the top cover. A concave part for accommodating the lamp cap column is arranged on an end surface of the second lamp cap against which the lamp cap column abuts, and an external thread is arranged on an outer circumference on one side of the second lamp cap distal from the top cover. The light emitted from the light emitting diode passes through the first lamp cap so as to change the light color.

In the electronic cigarette, the first lamp cap is made of transparent or semi-transparent material, the second lamp cap is made of metal, transparent or semi-transparent material, and the first and second lamp caps are adhered together.

When implementing the embodiments of this invention, the following advantageous effect can be achieved: the lamp cover with different colors is added onto the previous lamp cover by changing the material and configuration of the lamp cap of electronic cigarette. In this way, the light emitted from the built-in light emitting diode passes through the lamp cover with different colors and then changes its color, so that the electronic cigarette can result in bright and colorful light or color effect and further meet user's individual requirement. Meanwhile, air inlets can be arranged on the contact surface of the first and second lamp caps that form the lamp cover, thus achieving more hidden arrangement for the air inlet.

### BRIEF DESCRIPTION OF THE DRAWINGS

In order to explain the technical solution in embodiments of this invention or in prior art more clearly, accompanying drawings needed to used in the embodiments or in the prior art will be introduced in the following. Obviously, the accompanying drawings described below are only some examples for this invention. Some other accompanying drawings can be obtained according to these ones for the skill in the art without any inventive work.

FIG. 1 is a structural diagram for a lamp cover of electronic cigarette in the prior art;

FIG. 2 is a sectional view for an electronic cigarette in the prior art;

FIG. 3 is a sectional view for a lamp cover in a first preferred embodiment of this invention;

FIG. 4 is a sectional view for a lamp cover in a second preferred embodiment of this invention;

FIG. 5 is a sectional view for a lamp cover in a third preferred embodiment of this invention;

FIG. 6 is a sectional view for a lamp cover in a fourth preferred embodiment of this invention;

FIG. 7 is a sectional view for an electronic cigarette using the lamp cover in a first preferred embodiment of this invention.

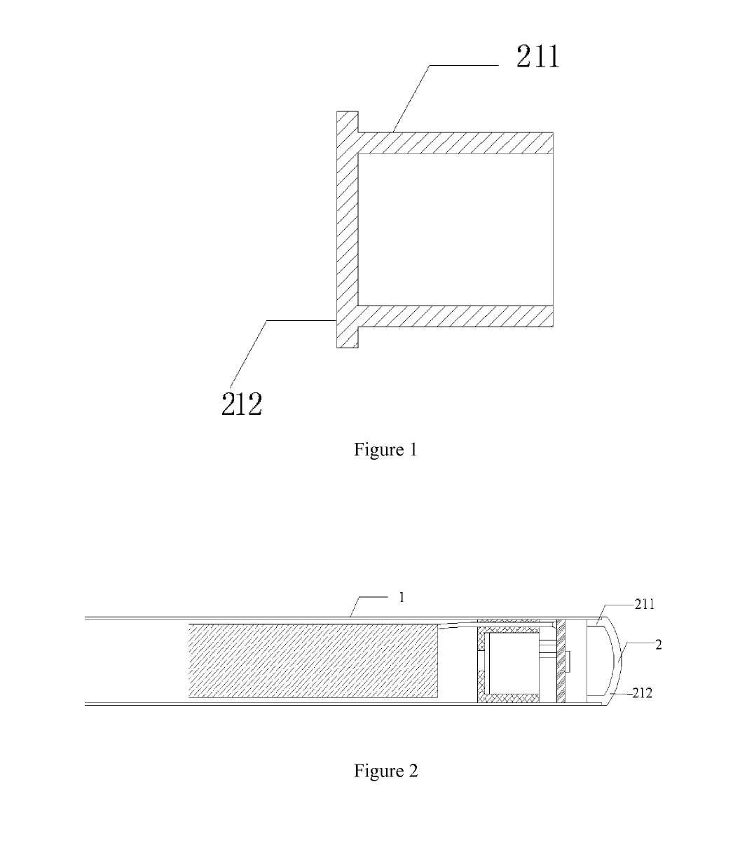

### DETAILED DESCRIPTION OF THE PREFERRED EMBODIMENT

In order to understand the objective, technical solution and advantages of this invention more clearly, this invention will be further explained in detail with reference to accompanying drawings and embodiments. It should be understood that the specific embodiments described here are only used for explanation instead of limitation of this invention.

### First Embodiment

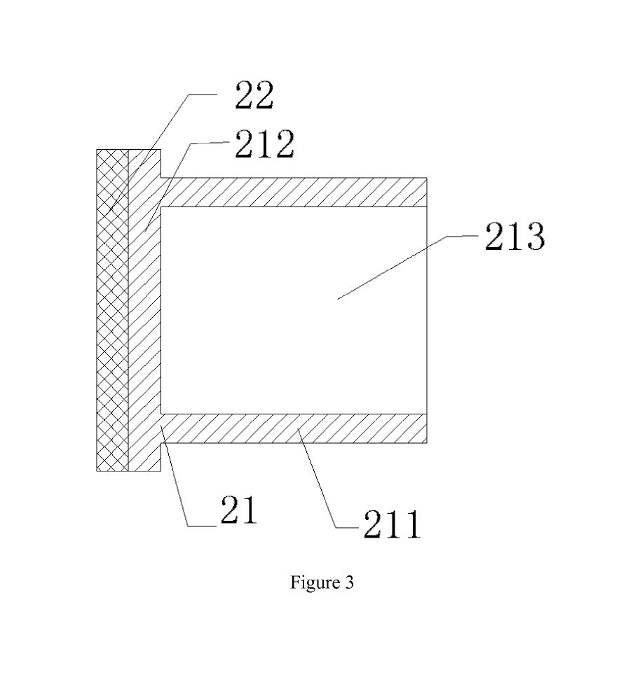

As shown in FIG. 3, in a first preferred embodiment of this invention, a lamp cover 2 comprises a first lamp cap 21 and a second lamp cap 22. The first lamp cap 21 is comprised of a top cover 212 and lamp cap columns 211, wherein the latter have a receiving cavity 213 and extend axially from a bottom surface of the top cover 212. The second lamp cap 22 is located on and further covers an upper end surface of the top cover 212, and its surface shape is adaptive with that of the upper end surface of the top cover 212. The upper end surface of the top cover 212 can be in the shape of square, circle or ellipse, which is covered by the second lamp cap 22. The two mentioned herein can be connected together detachably or fixedly. In the case of detachable connection, the following structural design can be adopted: at least one protrusion (not shown in figures) is disposed on the surface of the second lamp cap 22 that faces the upper end surface of the top cover 212, and at least one recess (not shown in figures) corresponding to the at least one protrusion of the second lamp cap 22 is disposed on the upper end surface of the top cover 212. Alternatively, at least one recess (not shown in figures) can also be disposed on the surface of the second lamp cap 22 that faces the upper end surface of the top cover 212, and at least one protrusion (not shown in figures) corresponding to the at least one recess of the second lamp cap 22 is disposed on the upper end surface of the top cover 212. All of the protrusions and recesses are arranged to be adaptive with each other, which can be designed in a number of 1, 2, 3 or 4, respectively. If more than two protrusions or recesses are adopted in the structural design, these protrusions or recesses are distributed on their respective end surfaces evenly spaced from each other. For the purpose of close connection between the first and second lamp caps 21 and 22, the optimum effect is achieved when there are three pairs of protrusions and recesses. The detachable connection mode enables users to use the lamp cap with different colors in combination in any way, perform replacement more conveniently and have their individual requirement be satisfied. The second lamp cap 22 can also be adhered onto and thus covers the upper end surface of the top cover 212 so that a fixed connection is formed between the first lamp cap 21 and the second lamp cap 22. The specific connection mode is not limited to that described above, which means screw connection or screwed connection can also be utilized.

A whole lamp cover is consisted of the first and second lamp caps 21 and 22. Herein, the first lamp cap 21 is made of semi-transparent material such as semi-transparent yellow polyvinyl fluoride (PVC) and semi-transparent ivory white acrylonitrile-butadiene-styrene (ABS) plastics, while the second lamp cap 22 is made of transparent material such as electroplated or sprayed transparent colorless polystyrene (PS) and polymethyl methacrylate (PMMA). In this case, the light passing through the first and second lamp caps can be changed to the color of the electroplated layer or the sprayed layer. Also, the first lamp cap 21 can be made of transparent material such as electroplated or sprayed PS or PMMA, and the second lamp cap 22 is made of semi-transparent material such as PVC or ABS.

As shown in FIG. 7, the lamp cover 2 is fixed onto the cigarette rod 1 through interference fit. The light emitted from the light emitting diode will change its color and further produce bright and colorful light or color effect when passing through the lamp cover. Meanwhile, the external wall of the lamp cap column 211 can be equipped with an elastic clamping component for fixing the lamp cover 2 for electronic cigarette onto the cigarette rod 1. In particular, the external wall of the lamp cap column 211 can also be arranged with a buckle (not shown in figures), and a slot (not shown in figures) in snap-fit with the buckle is corresponding disposed in the inner wall of the cigarette rod 1. Accordingly, the lamp cover 2 for electronic cigarette is detachably mounted at the end of the cigarette rod 1 through the snap-fit connection between such buckle and slot. It can be understood that a slot (not shown in figures) can also be disposed in the inner wall of the cigarette rod 1 and a buckle cooperating with this slot can be disposed on the external wall of the lamp cap column 211 so that the cigarette rod and the lamp cover for electronic cigarette is detachably connected with each other.

### Second Embodiment

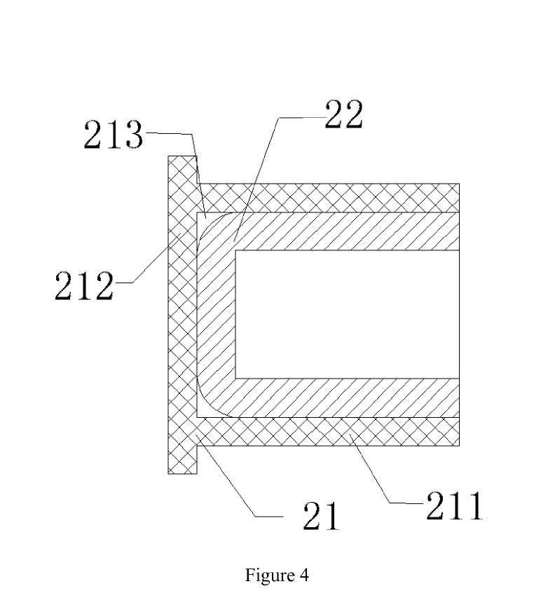

As shown in FIG. 4, in a second preferred embodiment of this invention, a first lamp cap 21 is comprised of a top cover 212 and lamp cap columns 211, wherein the latter have a receiving cavity 213 and extend axially from a bottom surface of the top cover 212. The cross section of the second lamp cap 22 is U-shaped, and it can be designed to be a hollow cylinder. Besides, the external diameter of the second lamp cap 22 is adaptive with the receiving cavity 213 in such a way that the second lamp cap 22 is sleeved by and pressed against the receiving cavity 213. Herein, the first and second lamp caps 21 and 22 are made of semi-transparent material. For example, the first lamp cap 21 is semi-transparent yellow polyvinyl fluoride (PVC) and the second lamp cap 22 is semi-transparent ivory white acrylonitrile-butadiene-styrene (ABS) plastic. Also the first and second lamp caps 21 and 22 can be made of electroplated or sprayed transparent material. For instance, the first lamp cap 21 is PS, and the second lamp cap 22 is polymethyl methacrylate (PMMA). The second lamp cap 22 is connected with the receiving cavity 213 through interference fit. Of course, snap-fit connection can also be used to connect two so that it is easy to replace the second lamp cap 22 by taking it from the receiving cavity 213. It is also possible to adhere the second lamp cap 22 into the receiving cavity 213 to form a fixed connection between the first and second lamp caps 21 and 22. Specific connection mode is not limited to what mentioned above, which means screw connection or screwed connected can also be adopted. The connection relation between the lamp cover 2 and the cigarette rod 1 is the same as that in the first preferred embodiment.

### Third Embodiment

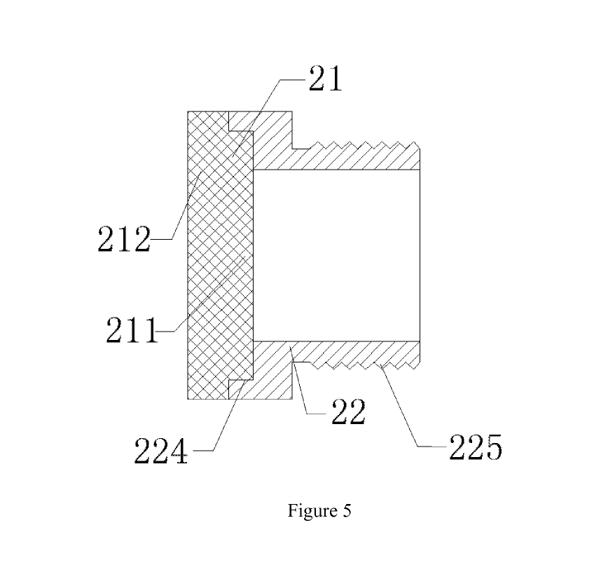

As shown in FIG. 5, in a third preferred embodiment of this invention, the first lamp cap 21 is made of transparent or semi-transparent material such as PVC, ABS, PS or PMMA in the first preferred embodiment. The first lamp cap 21 is comprised of a top cover 212 and lamp cap columns 211 extending axially from a bottom surface of the top cover 212. The second lamp cap 22 is a hollow cylinder made of metal material such as copper and aluminium alloy, while its external surface can also be subjected to electroplated or oxidation treatment. The second lamp cap 22 can also be made of transparent or semi-transparent material such as PVC, ABS, PS or PMMA in the first preferred embodiment. The external surface of the second lamp cap 22 is provided with threads, and its end surface being pressed against the lamp cap column 211 is provided with a concave part 224 for receiving the lamp cap column 211. Surface shape of the concave part 224 is adaptive with the lamp cap column 211 so that the two mate with each other. External thread 225 is arranged on an outer circumference on one side of the second lamp cap 22 distal from the top cover 212. The first and second lamp caps 21 and 22 can form into one piece through adhered mode or snap-fit mode, which is not illustrated in detail herein. Such external thread 223 matches with an internal thread disposed on an inner wall of the cigarette rod 1. The two brings about detachable connection while mating with each other. In the third preferred embodiment of this invention, the lamp cover including a set of outer materials with different colors is used.

As a result, when a user replaces the lamp cap at any time, the electronic cigarette can twinkle in various lights with completely different colors so as to meet user's individual requirement.

### Fourth Embodiment

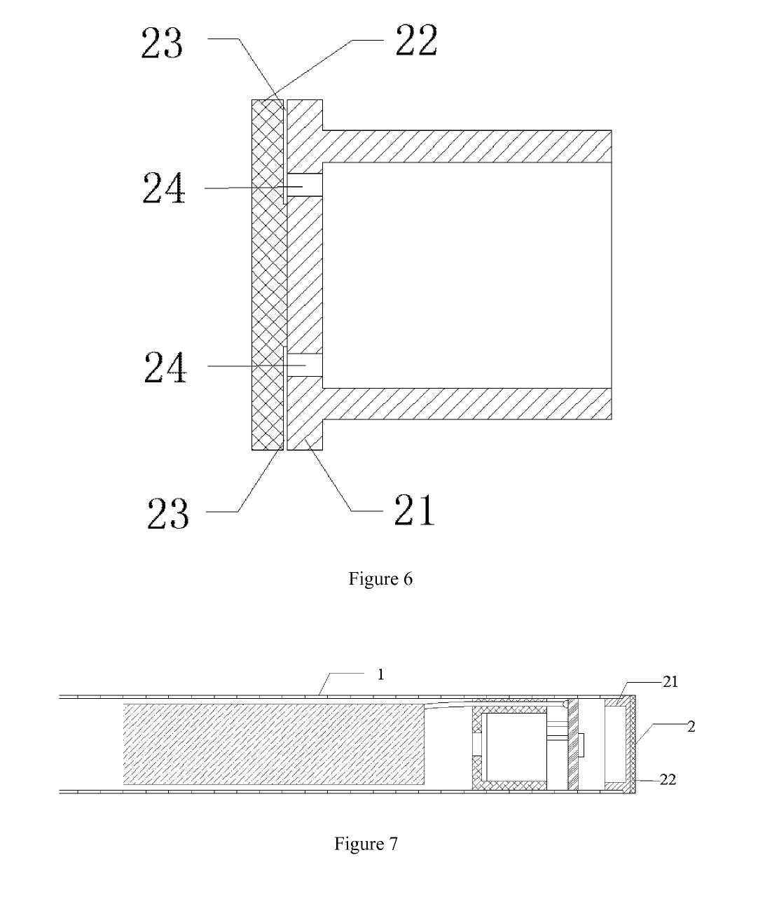

As shown in FIG. 6, a fourth preferred embodiment is an improvement to the first preferred embodiment. Herein, at least one vent groove 23 is disposed on a surface of the second lamp cap 22 by which it is in contact with the first lamp cap 21. Preferably, two vent grooves 23 are constructed in an optimal embodiment of this invention. Such two vent grooves 23 are further arranged symmetrically on the second lamp cap 22. At least one vent hole 24 is correspondingly disposed on the top cover 212 of the first lamp cap 21. Preferably, two vent grooves 23 are constructed in an optimal embodiment of this invention. In the event that the second lamp cap 22 covers the first lamp cap 21, the vent groove 23 and the vent hole 24 form an air passage communicating to external environment, and the vent hole 24 simultaneously is connected to the receiving cavity 213 of the first lamp cap 21. Also, the vent groove and the corresponding vent hole can be three, four or five. When implementing the lamp cover for electronic cigarette and the electronic cigarette using the same, air enters the airflow passage inside the cigarette rod of electronic cigarette by passing through the vent groove and the vent hole, as a result of which it is remained to be smooth in the airflow passage, thus reducing the noise during smoking and increasing user's experience. Meanwhile, an air inlet is disposed on the contact surface of the first and second lamp caps 21 and 22 in such a way that it is no longer needed to have any other holes on the cigarette rod of electronic cigarette. Accordingly, it is aesthetic in appearance instead of being weird due to one air inlet arranged on the cigarette rod. Moreover, the position of air inlet is more concealed and has no influence on the smoothness of airflow. Based on the same reason, corresponding improvement can be made on the second and third preferred embodiments through the same improvement method as that in the fourth one, which is thus not listed herein.

1. A lamp cover (2) comprising a first lamp cap (21); the first lamp cap (21) comprises a top cover (212) and lamp cap columns (212) which have a receiving cavity (213) and extend axially from a bottom surface of the top cover (212); wherein further comprising a second lamp cap (22), the second lamp cap (22) is located on an upper end surface of the top cover (212) or within the receiving cavity (213); the first lamp cap (21) and the second lamp cap (22) are connected with each other detachably or fixedly.

2. The lamp cover according to claim 1, wherein the shape of the second lamp cap (22) is adaptive with that of the upper end surface of the top cover (212), and the second lamp cap (22) covers the upper end surface.

3. The lamp cover according to claim 2, wherein at least one vent groove (23) is disposed on a surface of the second lamp cap (22) by which it is in contact with the first lamp cap (21), and at least one vent hole (24) is correspondingly disposed on the top cover (212) of the first lamp cap (21); the vent groove (23) and the vent hole (24) form a passage for air flow.

4. The lamp cover according to claim 2, wherein at least one recess is disposed on the second lamp cap (22), and the upper end surface of the top cover (212) is disposed with at least one protrusion at the location corresponding to the recess; alternatively, at least one protrusion is disposed on the second lamp cap (22), and the upper end surface of the top cover (212) is disposed with at least one recess at the location corresponding to the protrusion.

5. The lamp cover according to claim 2, wherein the second lamp cap (22) is adhered onto the first lamp cap (21).

6. The lamp cover according to claim 1, wherein the second lamp cap (22) is sleeved within the receiving cavity (213) and its cross section is U-shaped.

7. The lamp cover according to claim 6, wherein the second lamp cap (22) is in interference fit with the receiving cavity (213) or is adhered within the receiving cavity (213).

8. The lamp cover according to claim 1, wherein both the first (1) and second lamp caps (22) are made of transparent or semi-transparent material.

9. A lamp cove comprising a first lamp cap (21); the first lamp cap (21) comprises a top cover (212) and lamp cap columns (211) extending axially from a bottom surface of the top cover (212); wherein further comprising a second lamp cap (22) which is a hollow cylinder; a concave part (224) for accommodating the lamp cap column (211) is arranged on an end surface of the second lamp cap (22) against which the lamp cap column (211) abuts, and external thread (225) is arranged on an outer circumference on one side of the second lamp cap (22) distal from the top cover (212).

10. The lamp cover according to claim 9, wherein the first lamp cap (21) is made of transparent or semi-transparent material, the second lamp cap (22) is made of metal, transparent or semi-transparent material, and the first (21) and second lamp caps (22) are adhered together.

11. An electronic cigarette comprising a lamp cover (2) and a cigarette rod (1); the lamp cover (2) is connected in proximity to one end of the cigarette rod (1) with a built-in light emitting diode; the lamp cover (2) comprises a first lamp cap (21); the first lamp cap (21) comprises a top cover (212) and lamp cap columns (211) which have a receiving cavity (213) and extend axially from a bottom surface of the top cover (212); wherein further comprising a second lamp cap (22); the second lamp cap (22) is located on an upper end surface of the top cover (212) or within the receiving cavity (213); wherein the first (21) and second lamp caps (22) are connected with each other detachably or fixedly; the light emitted from the light emitting diode passes through the first (21) and second lamp caps (22) so as to change the light color.

12. The electronic cigarette according to claim 11, wherein the shape of the second lamp cap (22) is adaptive with that of the upper end surface of the top cover (212), and the second lamp cap (22) covers the upper end surface.

13. The electronic cigarette according to claim 12, wherein at least one vent groove (23) is disposed on a surface of the second lamp cap (22) by which it is in contact with the first lamp cap (21), and at least one vent hole (24) is correspondingly disposed on the top cover (212) of the first lamp cap (21); the vent groove (23) and the vent hole (24) form an airflow passage.

14. The electronic cigarette according to claim 12, wherein at least one recess is disposed on the second lamp cap, and the upper end surface of the top cover (212) is disposed with at least one protrusion at the location corresponding to the recess; alternatively, at least one protrusion is disposed on the second lamp cap, and the upper end surface of the top cover (212) is disposed with at least one recess at the location corresponding to the protrusion.

15. The electronic cigarette according to claim 12, wherein the second lamp cap (22) is adhered onto the first lamp cap (21).

16. The electronic cigarette according to claim 11, wherein the second lamp cap (22) is sleeved within the receiving cavity (213) and its cross section is U-shaped.

17. The electronic cigarette according to claim 16, wherein the second lamp cap (22) is in interference fit with the receiving cavity (213).

18. The electronic cigarette according to claim 11, wherein both the first (21) and second lamp caps (22) are made of transparent or semi-transparent material.

19. An electronic cigarette comprising a lamp cover (2) and a cigarette rod (1); the lamp cover (2) is connected in proximity to one end of the cigarette rod (1) with a built-in light emitting diode; the lamp cover (2) comprises a first lamp cap (21); the first lamp cap (21) comprises a top cover (212) and lamp cap columns (211) extending axially from a bottom surface of the top cover (212); wherein further comprising a second lamp cap (22) in a shape of circle; a concave part (224) for accommodating the lamp cap column (211) is arranged on an end surface of the second lamp cap (22) against which the lamp cap column (211) abuts; an external thread (225) is arranged on an outer circumference on one side of the second lamp cap (22) distal from the top cover (212), and the cigarette rod (1) is provided with an internal thread matching with the external thread (225); the light emitted from the light emitting diode passes through the first lamp cap (21) so as to change the light color.

20. The electronic cigarette according to claim 19, wherein the first lamp cap (21) is made of transparent or semi-transparent material, the second lamp cap (22) is made of metal, transparent or semi-transparent material, and the first (21) and second lamp caps (22) are adhered together.
